(19) United States
(12) Patent Application Publication
(10) Pub. No.: US 2004/0000765 A1
(43) Pub. Date: Jan. 1, 2004

(54) Support stand for snowmobile

(76) Inventor: Michael Ouellette, Caribou, ME (US)

Correspondence Address: BOHAN, MATHERS & ASSOCIATES, LLC, PO BOX 17707, PORTLAND, ME, 04112-8707, US

(21) Appl. No.: 10/186,792

(22) Filed: Jul. 1, 2002

(51) Int. Cl. B62D 61/12

(52) U.S. Cl. 280/43

(57) ABSTRACT

Apparatus for providing a rolling mechanism beneath the rear-end of a snowmobile to improve the maneuverability of the snowmobile when it is being transported across a non-snow or non-ice surface.

### BACKGROUND OF THE INVENTION

1. Field of the Invention

This invention relates to the field of snowmobiles.

2. Description of the Prior Art

Snowmobiles are vehicles that are constructed to travel across snow and ice. As is generally known, the snowmobile is driven by an endless drive track arranged at the rear end of the underside of the snowmobile. The front end of the snowmobile is supported by, and rides along, two skis, which glide across the surface of the snow or ice. Typically, the skis have carbide inserts that run along a portion of the bottom surface of the ski runner and aid in the steering of the snowmobile.

A disadvantage of snowmobiles is that, when taken out of the their designed snow environment, they become quite difficult to transport because the skis and track drive do not readily glide along the surface when traveling across gravel, hardtop, or other non-snow surfaces. Therefore, even the most trivial of movements, such as, moving from one side of the garage to the other, requires a tremendous amount of effort and strength, requiring one to repeatedly lift and drag the snowmobile to its desired location. Often the owner resorts to alternating lifting and dragging the front of the snowmobile a few inches, then switches to lifting and dragging the back end to catch up with the front. It is easy to see how this movement would be difficult for riders who are not physically very strong, and is, at best, rather strenuous for even those riders who have a great deal of physical strength.

Such challenges are not limited to moving a snowmobile around a driveway or garage. Loading and unloading the snowmobile onto a flat-bed or a trailer, a common task for most snowmobile riders, presents another physically challenging task, even for the strongest of riders. Although the track drive can provide some of the moving power, the snowmobile is not at all steerable on non-snow surfaces and still needs to be guided by the operators to ensure that the snowmobile travels in the desired direction. Normally two riders team up to guide and/or push the snowmobile in the desired direction—one rider mounts the snowmobile and operates the throttle, and the other pushes and guides the snowmobile. This cooperative effort is potentially extremely hazardous to the person guiding the snowmobile, as an unexpected fluctuation in the throttle can cause the snowmobile to lurch or jump, presenting the potential of severely injuring that person if he or she is in the path of the lurching snowmobile.

Not only is snowmobile movement on non-snow surfaces difficult, such movement is potentially damaging to the snowmobile as well. For example, driving or dragging a snowmobile across a non-snow surface subjects the track and the carbide tips on the skis to excessive wear and, as a result, they may require more frequent replacement.

Lack of accessibility to the lower portions of the machine, such as the drive track, can also present a difficulty to the rider. For example, to make adjustments to the drive track, the back end of the snowmobile must be propped up off the ground to allow free track movement. Typically, this is achieved in the shop by propping it up on cinder blocks, bricks, or resting it on a jack. This solution is inadequate for reasons of safety and convenience. For example, propping a snowmobile up on blocks is unsafe as it may fall over if jostled. Additionally, the rider who needs to make adjustments while out for a ride, generally does not have blocks or a jack available to support the snowmobile in a raised position.

What is needed, therefore, is apparatus for securing a snowmobile in an upright position, with the rear end of the snowmobile raised above the ground. What is further needed is such apparatus that is easily operable without requiring a great deal of physical strength. What is yet further needed is such apparatus that will allow the vehicle to be maneuvered easily over a surface that is not snow or ice. What is still yet further needed is such apparatus that will improve the steerability of a snowmobile while it is being maneuvered across a surface that is not snow or ice.

### SUMMARY OF THE INVENTION

For the reasons cited above, it is an object of the present invention to provide apparatus that will secure a snowmobile in an upright position, with the rear end of the snowmobile raised above the ground. It is a further object to provide such apparatus that is easily operable by a single person, without requiring great physical strength. It is a yet further object to provide such apparatus that allows a single person to easily steer a snowmobile while maneuvering it across a surface that is not snow and/or ice.

The objects of the present invention have been achieved by providing a center stand that is attached to the rear end of a snowmobile and easily and/or automatically deploys when the rear end of the snowmobile is lifted slightly. The center stand is a bar that extends from one side of the snowmobile to the other and is attached by means of side arms to the chassis of the snowmobile. The side arms are pivotable between a locked, deployed condition and a stowed condition. A means for releasing the center stand from the stowed condition or for releasing the locking mechanism from the deployed condition is also provided.

Attached to the bottom of the center stand is at least one wheel. If the skis on the snowmobile are also equipped with wheels, such as are disclosed in U.S. patent application Ser. No. 09/818,058, incorporated herein by reference, the center stand with wheel now allows the snowmobile to glide easily and steerably across a non-snow, non-ice surface.

### BRIEF DESCRIPTION OF THE DRAWINGS

FIG. 1 is a plan view of the center stand according to the present invention.

FIG. 2 is an elevational view of a snowmobile equipped with convertible skis with wheels and the center stand according to the present invention, the center stand and the wheels on the skis being in respective non-deployed positions.

FIG. 3 shows the mounting bracket and the deployment link of the present invention.

FIG. 4 is an elevational view of the snowmobile of FIG. 2, with the center stand and the ski wheels being in fully deployed position.

FIG. 5 is a partial view of the snowmobile of FIG. 2, equipped with the center stand according to the invention, the center stand having a fluid-pressure actuating means.

### DETAILED DESCRIPTION OF THE INVENTION

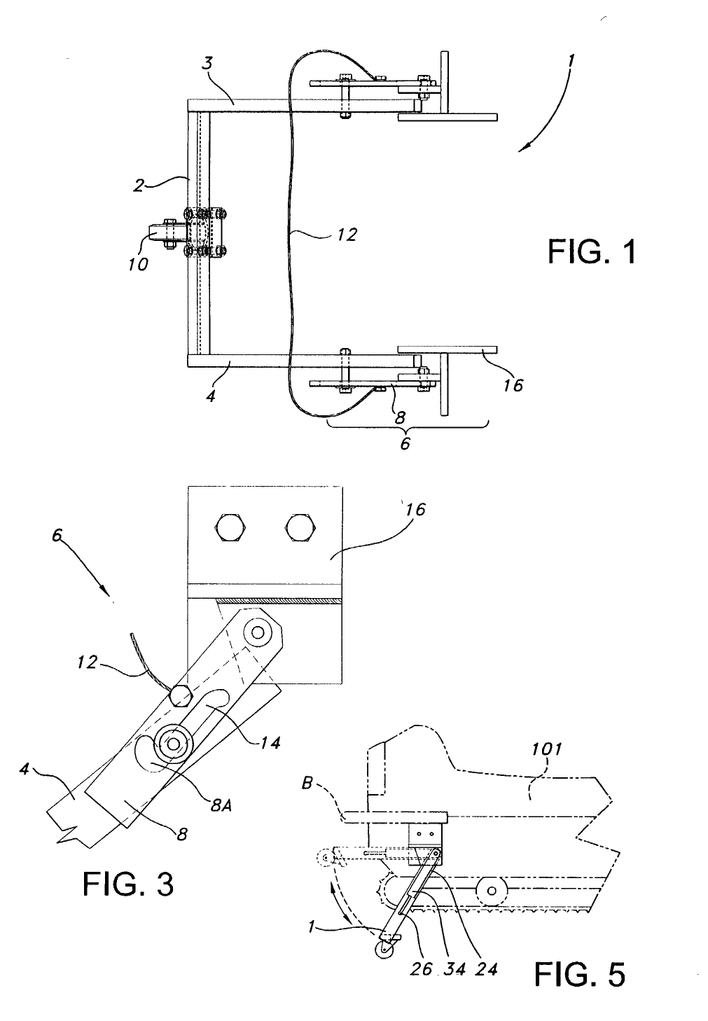

FIG. 1 is an illustration of an embodiment of a center stand 1 according to the present invention. The center stand 1 comprises a frame 3 and a rolling mechanism 10. The frame 3 in the embodiment shown includes a crossbar 2 and two side arms 4. At the distal end of each side arm 4 is an attachment and deployment means 6 by which the center stand 1 is pivotably attached to the body of a conventional snowmobile. Other embodiments of the frame 3 may be U-shaped or otherwise contoured so that the frame 3 is connectable to the body of a snowmobile in a way that does not hinder or interfere with the conventional operations of the snowmobile. In the particular embodiment shown in FIG. 1, the attachment and deployment means 6 includes a mounting bracket 16 and a deployment link 8 that is pivotably attached to the respective mounting bracket 16 at one end and to the side arm 4 at the other end. The rolling mechanism 10 is mounted on the crossbar 2, which, in the embodiment shown is a wheel. It is, of course, possible to mount more than one wheel on the crossbar 2 or to use some other suitable type of rolling mechanism 10 other than the wheel, such as a track with roller balls.

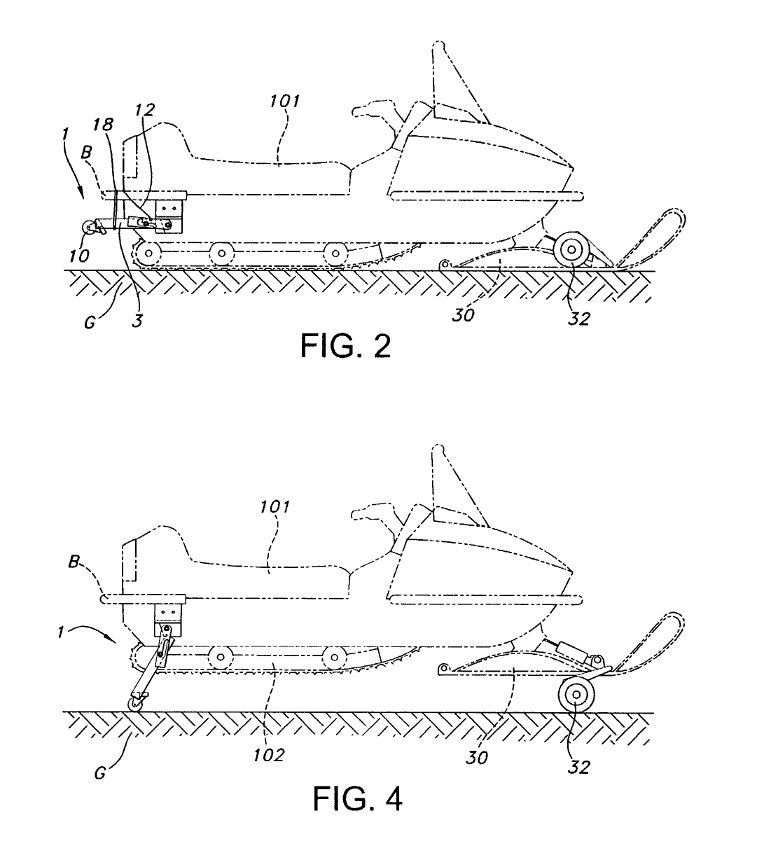

FIG. 2 shows the center stand 1 mounted on a conventional snowmobile 101 and secured in a stowed position by a retainer 18. The retainer 18 shown in this embodiment is a simple strap, but it should be understood that any suitable means for securing the center stand 1 can be used, such as a mechanical or electromechanical latch, a magnetic or electromagnetic latch, a hasp and staple, etc. Also shown on the snowmobile 101 is a convertible ski 30 that has a ski-wheel 32 deployably attached to it. This convertible ski 30 is the subject of U.S. patent application Ser. No. 09/818,058, commonly owned by the inventor of the present invention. As shown in FIG. 2, the ski-wheel 32 is raised above the ground in a non-deployed position.

FIG. 3 illustrates the attachment and deployment mechanism 6 for releasing the center stand 1 from a stowed position to a deployed position. The deployment link 8 is pivotably attached to the mounting bracket 16 and slidably attached to the side arm 4 and has a groove 14 that has a catch 8A for securing the side arm 4 in the deployed position. The mounting bracket 16 is securely affixed to each side of the conventional snowmobile 101 such that the center stand 1, when in the stowed position, is in the vicinity of a bumper B that is conventionally mounted on the snowmobile 101. A deployment cable 12 is connected to the deployment link 8 attached to the mounting bracket 16 on one side of the center stand 1 to the mounting bracket 16 on the other side of the center stand 1. For the sake of clarity, a mudflap that is typically attached to the snowmobile 101 beneath the bumper B is not shown.

To release the center stand 1 from the stowed position shown in FIG. 2 to a deployed position shown in FIG. 4, one pulls releases the retainer 18. In the embodiment shown in the FIGS. 2 and 4, the deployment link 8 and the center stand 1 drop simply to the ground by force of gravity. By lifting slightly on the rear bumper of the snowmobile 101, the center stand 1 rolls under the snowmobile 101 and the deployment link 8 snaps into the catch 8A and holds the center stand 1 in the fully deployed position under the rear end of the snowmobile 101. FIG. 4 shows the snowmobile 101, equipped with the center stand 1 according to the present invention, and the convertible skis 30 with wheels 32. As shown, the rear end of the snowmobile is raised above ground level and supported on the rolling mechanism 10 when the center stand 1 is deployed. If the wheels 32 on the convertible skis 30 are deployed as well, the front end of the snowmobile 101 is also raised above ground level. In this position, the snowmobile 101 can be maneuvered easily across a surface that is neither snow nor ice. In addition, if the rolling mechanism 10 is a wheel that is swivel-mounted or roller balls that allow rotation in any direction, the snowmobile 101 can also be steered as it is pushed or pulled in a backward direction.

FIG. 5 illustrates another embodiment of the invention in which the deployment means 6 is a drive means 34 that drives the frame 3 into a deployed position as well as to a stowed position. The drive means 34 includes a cylinder 24 and a piston 26. As shown, the cylinder 24 is mounted on a side arm of the frame 4 and the operating end of the piston 26 is attached to the mounting block 16 so as to drive the frame 3 to a stowed position (shown with dotted lines) from a deployed position and vice versa. Fluid-pressure drive means such as the piston and cylinder drive means 34 shown in FIG. 5 are generally well-known and the details of such means and their means of actuation are neither discussed nor shown herein. It is within the scope of the invention, however, that such drive means 34 may be driven by any suitable pressurized fluid system, such as air or hydraulic fluid.

The embodiments described herein are merely illustrative of the present invention. It should be understood that variations in construction of the present invention may be contemplated in view of the following claims, without straying from the intended scope and field of the invention herein disclosed.

What it is claimed is:

1. A device for supporting a conventional snowmobile, said device comprising:
a frame;
a rolling mechanism mounted on said frame;
a mounting bracket for mounting said frame on said snowmobile; and
a deployment means for releasing said frame from a stowed position to a deployed position.

2. The device of claim 1, wherein said rolling mechanism is a wheel mounted on said frame.

3. The device of claim 2, wherein said wheel is a swivel caster.

4. The device of claim 1, wherein said frame is substantially U-shaped, having a center section with a first side arm and a second side arm, wherein said mounting bracket includes a first mounting bracket and a second mounting bracket, wherein said first side arm is connected to said first mounting bracket and said second side arm to said second mounting bracket.

5. The device of claim 1, wherein said deployment means includes a link with a guide groove having a deployment-position catch, wherein said link is pivotably connected at one end to said mounting bracket and slidably connected to said frame by means of a fastener that has a first end that is attached to said frame and a second end that is slidably restrained in said guide groove, and wherein said fastener is restrainable in said deployment-position catch when said device is deployed.

6. The device of claim 1, wherein said deployment means is a drive means that includes a cylinder and piston, wherein said cylinder is mounted on said mounting bracket and an operating end of said piston is connected to said frame so as to move said frame from said stowed position to said deployed position and from said deployed position to said stowed position.
